(19) United States
(12) Patent Application Publication
(10) Pub. No.: US 2015/0169104 A1
(43) Pub. Date: Jun. 18, 2015

(54) TOUCH PANEL

(71) Applicant: SAMSUNG ELECTRO-MECHANICS CO., LTD., Suwon-Si (KR)

(72) Inventors: Jang Ho PARK, Suwon-Si (KR); Doo Ho PARK, Suwon-Si (KR); Jung Ryoul YIM, Suwon-Si (KR); In Hyun JANG, Suwon-Si (KR)

(73) Assignee: SAMSUNG ELECTRO-MECHANICS CO., LTD., Suwon-Si (KR)

(21) Appl. No.: 14/197,013

(22) Filed: Mar. 4, 2014

(30) Foreign Application Priority Data
Dec. 17, 2013 (KR) 10-2013-0157310

(51) Int. Cl. G06F 3/044

(52) U.S. Cl. CPC G06F 3/044

(57) ABSTRACT

A transparent electrode may include: an electrode layer formed to have a net pattern; and a visibility improvement layer formed on at least one surface of the electrode layer and having a color darker than that of the electrode layer and electrical conductivity.

### CROSS-REFERENCE TO RELATED APPLICATION

This application claims the benefit of Korean Patent Application No. 10-2013-0157310, filed on Dec. 17, 2013, with the Korean Intellectual Property Office, the disclosure of which is incorporated herein by reference.

### BACKGROUND

The present disclosure relates to a touch panel.

A touch sensing apparatus such as a touchscreen, a touch pad, or the like, an input apparatus attached to a display apparatus to provide users with an intuitive data input method, has recently been widely used in various electronic devices such as cellular phones, personal digital assistants (PDA), navigation devices, and the like. Particularly, as demand for a smartphones has recently increased, the use of touchscreens allowing for various input methods and gestures in a limited form factor has increased on a day by day basis.

Touchscreens used in portable devices may be mainly divided into resistive type touchscreens and capacitive type touchscreens, according to a method of sensing a touch input utilized thereby. Here, the capacitive type touchscreen has advantages in that it has a relatively long lifespan and may easily allow for various data input methods and gestures, such that the use thereof has increased on a day by day basis. Particularly, capacitive type touchscreens may more easily allow for the implementation of a multi-touch interface, as compared to resistive type touchscreens, such that capacitive type touchscreens are widely used in devices such as smartphones, and the like.

Capacitive type touchscreens commonly include a plurality of electrodes having a predetermined pattern and defining a plurality of nodes in which changes in capacitance are generated by touch inputs. In the plurality of nodes distributed on a two-dimensional plane, changes in self-capacitance or mutual-capacitance are generated by a touch. A coordinate of a touch may be calculated by applying a weighted average method, or the like, to the changes in capacitance generated in the plurality of nodes.

In a touch panel according to the related art, generally, a sensing electrode recognizing touches was formed of indium tin oxide (ITO). However, since indium is a rare earth metal, ITO is expensive, such that price competitiveness may be low, as well as the fact that world indium reserves are expected to be depleted within the next decade, such that the indium may not be smoothly supplied.

Due to the above-mentioned reasons, research into a method of forming an electrode using an opaque conductive thin line has been conducted. Such an electrode formed of a conductive thin line material, such as a metal, has advantages in that electrical conductivity is significantly excellent as compared to an electrode formed of ITO or a conductive polymer and the conductive thin line may be smoothly supplied.

However, in the case of using such a conductive thin line to form the electrode, there is a problem in that visibility may be decreased by a moiré phenomenon, due to an ordered conductive thin line, and reflections from the metal.

Particularly, a reflective diffraction phenomenon may be generated due to a predetermined pattern of the conductive thin line and the reflections from the metal.

The reflective diffraction phenomenon is a phenomenon in which, when light such as solar light, or the like, is applied to a surface on which a conductive thin line having a predetermined pattern is provided, diffraction is generated, and this reflective diffraction phenomenon becomes a main cause of deteriorating visibility of the touch panel.

Further, the moiré phenomenon is a phenomenon generated while patterns having a predetermined interval are repeatedly overlapped with each other. In the case of using the conductive thin line to form a 2-axis sensor electrode, patterns of the conductive thin line are overlapped with each other on each axis to generate the moiré phenomenon, which becomes another cause of deteriorating visibility of the touch panel.

In order to improve visibility of the touch panel, a solution for decreasing the reflective diffraction phenomenon and moiré phenomenon is demanded.

### SUMMARY

An aspect of the present disclosure may provide a touch panel in which visibility is improved.

According to an aspect of the present disclosure, a touch panel may include: an electrode layer formed to have a net pattern; and a visibility improvement layer formed on at least one surface of the electrode layer and having electrical conductivity.

The visibility improvement layer may contain at least one selected from a group consisting of TiN, CrN, TiNxOy (0<x<1, 0<y<1), and CrNxOy (0<x<1, 0<y<1).

The visibility improvement layer may have a thickness of 20 nm to 90 nm.

The visibility improvement layer may be formed on both surfaces of the electrode layer.

According to another aspect of the present disclosure, a touch panel may include: a transparent substrate; a first sensor electrode including an electrode layer formed to have a net pattern and a visibility improvement layer formed on at least one surface of the electrode layer, and formed on a lower surface the transparent substrate; an insulating layer formed on the lower surface the transparent substrate so as to enclose the first sensor electrode; and a second sensor electrode including an electrode layer formed to have a net pattern and a visibility improvement layer formed on at least one surface of the electrode layer, and formed on a lower surface the insulating layer, wherein the visibility improvement layer has electrical conductivity.

The visibility improvement layer may contain at least one selected from a group consisting of TiN, CrN, TiNxOy (0<x<1, 0<y<1), and CrNxOy (0<x<1, 0<y<1).

The visibility improvement layer may have a thickness of 20 nm to 90 nm.

The visibility improvement layer may be positioned on one surface of the electrode layer in a user's viewing direction.

The visibility improvement layer may be formed on both surfaces of the electrode layer.

According to another aspect of the present disclosure, a touch panel may include: a transparent substrate; a first sensor electrode including an electrode layer formed to have a net pattern and a visibility improvement layer formed on at least one surface of the electrode layer, and formed on an upper surface of the transparent substrate; a second sensor electrode including an electrode layer formed to have a net pattern and a visibility improvement layer formed on at least one surface of the electrode layer, and formed on a lower surface of the transparent substrate, wherein the visibility improvement layer has electrical conductivity.

The visibility improvement layer may contain at least one selected from a group consisting of TiN, CrN, TiNxOy (0<x<1, 0<y<1), and CrNxOy (0<x<1, 0<y<1).

The visibility improvement layer may have a thickness of 20 nm to 90 nm.

The visibility improvement layer may be positioned on one surface of the electrode layer in a user's viewing direction.

The visibility improvement layer may be formed on both surfaces of the electrode layer.

According to another aspect of the present disclosure, a touch panel may include: a first transparent substrate; a first sensor electrode including an electrode layer formed to have a net pattern and a visibility improvement layer formed on at least one surface of the electrode layer, and formed on a lower surface of the first transparent substrate; a first insulating layer formed on the lower surface of the first transparent substrate so as to enclose the first sensor electrode; a second transparent layer formed on a lower surface of the first insulating layer; a second sensor electrode including an electrode layer formed to have a net pattern and a visibility improvement layer formed on at least one surface of the electrode layer, and formed on a lower surface of the second transparent substrate; and a second insulating layer formed on a lower surface of the second transparent substrate so as to enclose the second sensor electrode, wherein the visibility improvement layer has electrical conductivity.

The visibility improvement layer may be positioned on one surface of the electrode layer in a user's viewing direction.

The visibility improvement layer may be formed on both surfaces of the electrode layer.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 schematically shows a plan view of a transparent electrode according to an exemplary embodiment of the present disclosure;

FIG. 2 schematically shows a cross-sectional view taken along line A-A′ of FIG. 1;

FIG. 3 is a graph schematically showing a brightness according to a thickness of a visibility improvement layer;

FIG. 4 shows a schematic cross-sectional view of a transparent electrode including visibility improvement layers on upper and lower surfaces of an electrode layers;

FIG. 5 shows a schematic cross-sectional view of a touch panel according to another exemplary embodiment of the present disclosure;

FIG. 6 shows a schematic cross-sectional view of a touch panel according to another exemplary embodiment of the present disclosure, including visibility improvement layers on upper and lower surfaces of an electrode layer;

FIG. 7 shows a schematic cross-sectional view of a touch panel according to another exemplary embodiment of the present disclosure;

FIG. 8 shows a schematic cross-sectional view of a touch panel according to another exemplary embodiment of the present disclosure, including visibility improvement layers on upper and lower surfaces of an electrode layer;

FIG. 9 shows a schematic cross-sectional view of a touch panel according to another exemplary embodiment of the present disclosure; and

FIG. 10 shows a schematic cross-sectional view of a touch panel according to another exemplary embodiment of the present disclosure, including visibility improvement layers on upper and lower surfaces of an electrode layer.

### DETAILED DESCRIPTION

Exemplary embodiments of the present disclosure will now be described in detail with reference to the accompanying drawings.

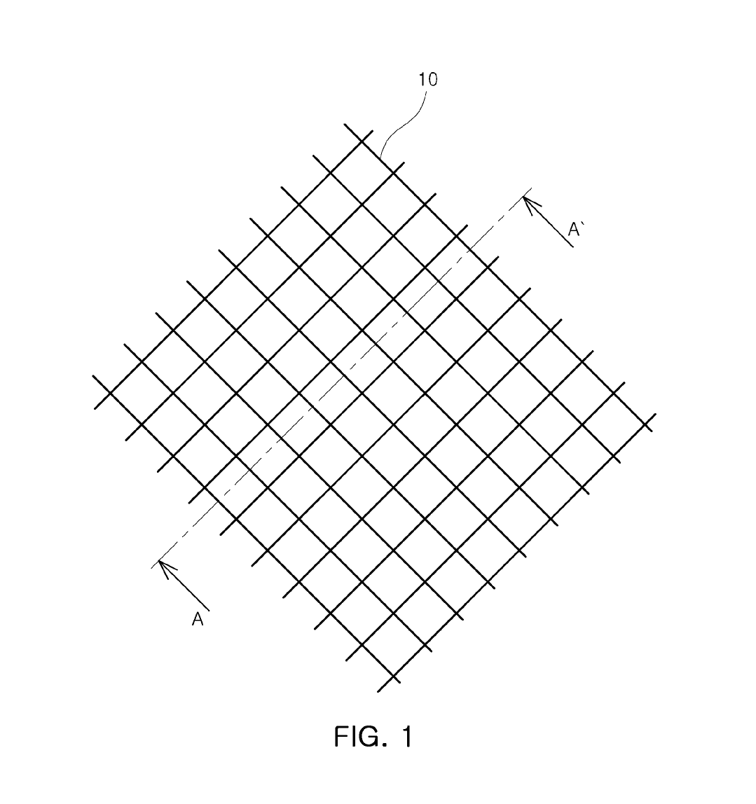

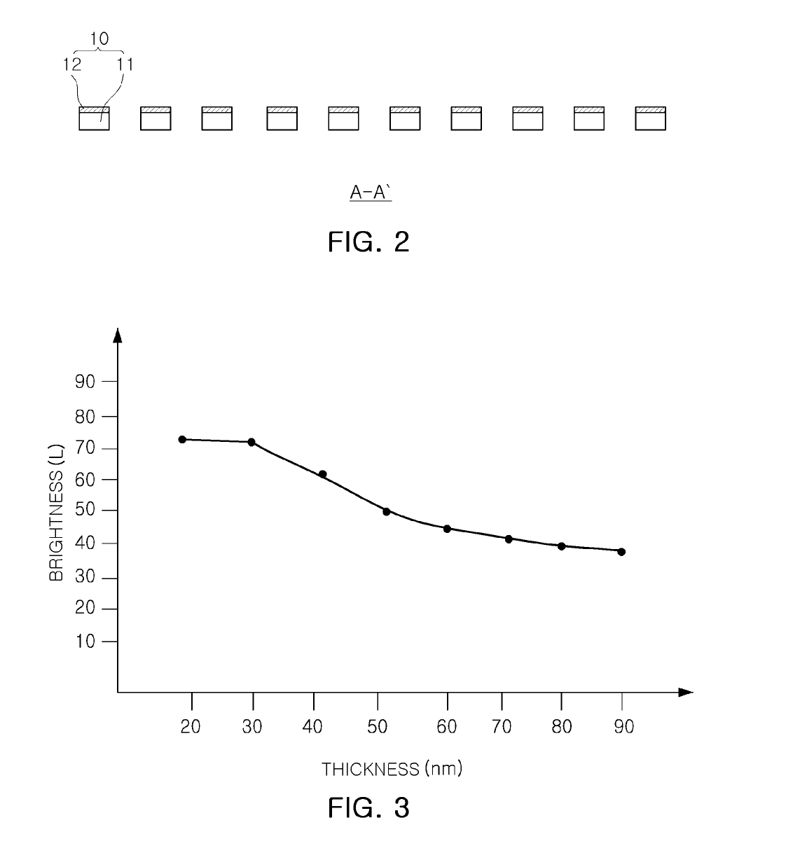

FIG. 1 shows a schematic plan view of an electrode layer 11 of a touch panel 10 according to an exemplary embodiment of the present disclosure, and FIG. 2 shows a schematic cross-sectional view taken along line A-A′ of FIG. 1.

Referring to FIGS. 1 and 2, the touch panel 10 according to an exemplary embodiment of the present disclosure will be described.

The touch panel 10 according to an exemplary embodiment of the present disclosure may include the electrode layer 11 and a visibility improvement layer 12.

The electrode layer 10 may be formed to have a net pattern using a conductive thin line.

The electrode layer 10 may be formed of any one metal of Ag, Al, Cr, Ni, Mo, and Cu or an alloy thereof and formed of a single layer or multiple layers.

Generally, a line width of the conductive thin line may be 0.5 to 10 μm.

In the case in which the line width is narrower than 0.5 μm, a defect rate may be increased due to disconnection, and a resistance value maybe increased, and in the case in which the line width is wider than 10 μm, transmittivity may be decreased.

The visibility improvement layer 12 may be formed on one surface of the electrode layer 11 of the touch panel 10.

The visibility improvement layer 12 may be formed using a material having a brightness lower than that of the electrode layer 11.

Since the visibility improvement layer 12 has a brightness lower than that of the electrode layer 11, in the case in which the visibility improvement layer 12 is used in the touch panel, recognition of the electrode layer by a user may be blocked.

That is, in the case of the electrode layer 11 not having the visibility improvement layer 12, since a generally used material such as Al has a color close to white, the electrode layer 11 may be easily recognized by the user of the touch panel.

However, in the touch panel 10 according to an exemplary embodiment of the present disclosure, since the visibility improvement layer 12 having a brightness lower than that of the electrode layer 11 covers one surface of the electrode layer 11, the electrode layer 11 may be not visible.

Therefore, in the case of using the touch panel 10 according to an exemplary embodiment of the present disclosure, visibility may be improved.

That is, in the case of using the electrode layer 11 including the visibility improvement layer 12 formed on one surface thereof as a sensor electrode of the touch panel 10, visibility may be improved, such that the sensor electrode may not be recognized by the user.

In addition, the visibility improvement layer 11 may be formed using a material having electrical conductivity.

The visibility improvement layer 11 is formed using the material having electrical conductivity, such that the touch panel 10 according to an exemplary embodiment of the present disclosure may be electrically connected to an external device such as a circuit board without a separate additional process.

In a touch panel according to the related art, since a separate insulating layer was formed in order to visibility, in order to electrically connect the touch panel to a circuit board, or the like, a patterning process for partially removing the insulating layer at the corresponding portion such as an exposure process, an etching process, or the like, was performed.

However, the visibility improvement layer 12 according to an exemplary embodiment of the present disclosure is formed using the material having electrical conductivity, such that the visibility improvement layer 12 may be electrically connected to the outside without a separate additional process.

For example, the visibility improvement layer 12 may be formed of at least one selected from a group consisting of TiN, CrN, TiNxOy (0<x<1, 0<y<1), and CrNxOy (0<x<1, 0<y<1).

The visibility improvement layer 12 may be formed by directly coating using a sputtering method, or the like.

Further, the visibility improvement layer may be formed using a metal as a target by a reactive sputtering method of adjusting contents and quantities of nitrogen and oxygen under argon atmosphere.

In the case of using the reactive sputtering method, the visibility improvement layer 12 having various compositions may be formed by adjusting the contents and quantities of nitrogen and oxygen.

In the case in which the visibility improvement layer 12 is formed, the visibility improvement layer 12 may serve to prevent corrosion of the electrode layer 11.

Therefore, reliability of the touch panel 10 according to an exemplary embodiment of the present disclosure may be improved.

FIG. 3 is a graph schematically showing a brightness according to a thickness of the visibility improving layer 12.

The graph of FIG. 3 is obtained by measuring the brightness according to the thickness based on TiN. CrN, TiNxOy, and CrNxOy have a brightness property similar to that of TiN.

It means that in the case in which a brightness of a material is 100, the material has a white color, and in the case in which the brightness is 0, the material has a black color.

In the case of pure Ti, the pure Ti has a brightness value of about 75.

Referring to FIG. 3, the thickness of the visibility improvement layer 12 may be 20 nm to 90 nm.

In the case in which the thickness of the visibility improvement layer 12 is less than 20 nm, a brightness of the visibility improvement layer 10 may be similar to or higher than that of pure Ti.

Therefore, in the case in which the thickness of the visibility improvement layer 12 is less than 20 nm, an effect of improving visibility may be decreased.

As the thickness of the visibility improvement layer 12 increases, the brightness gradually decreases, but a gradient gradually decreased.

Therefore, in the case in which the thickness of the visibility improvement layer 12 is more than 90 nm, the effect of improving visibility may be insignificant, but a thickness of the touch panel 10 may be increased.

Therefore, the thickness of the visibility improvement layer 12 of the touch panel 10 according to an exemplary embodiment of the present disclosure may be 20 nm to 90 nm.

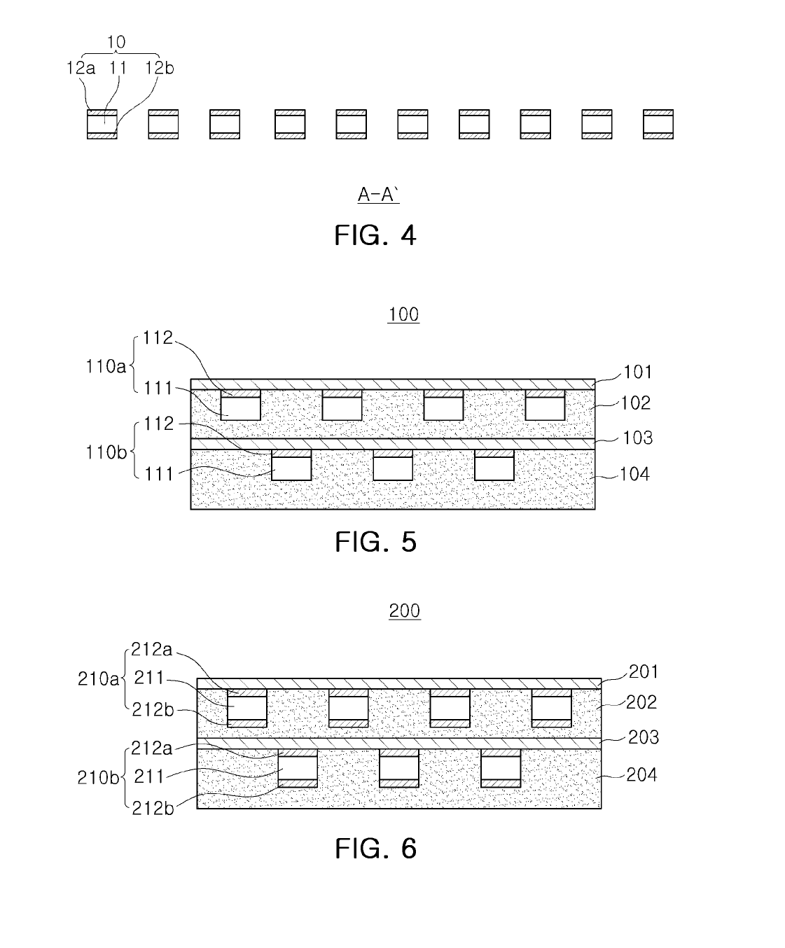

FIG. 4 schematically shows a cross-sectional view of a touch panel 10 including visibility improvement layers 12a and 12b on upper and lower surfaces of an electrode layer 11.

Referring to FIG. 4, in the touch panel 10 according to an exemplary embodiment of the present disclosure, the visibility improvement layers 12a and 12b may be formed on both surfaces of the electrode layer 11.

Since the visibility improvement layers 12a and 12b have electrical conductivity, in the case in which the visibility layer is formed on the lower surface of the electrode layer 11, a separate additional process for connecting the visibility to the outside is not required.

Further, the visibility improvement layers 12a and 12b are formed on both surfaces of the electrode layer 10, such that the visibility improvement layers may serve to more surely prevent corrosion of the electrode layer 11.

FIG. 5 shows a schematic cross-sectional view of a touch panel 100 according to another exemplary embodiment of the present disclosure.

Referring to FIG. 5, the touch panel 100 according to another exemplary embodiment of the present disclosure may include a first transparent substrate 101, a first sensor electrode 110a, a first insulating layer 102, a second transparent substrate 103, a second sensor electrode 110b, and a second insulating layer 104.

In the case of a mobile device, generally, a touch panel may be provided in a state in which it is integrally with a display apparatus, and the touch panel needs to have a high light transmittivity high enough to transmit a screen displayed by the display apparatus.

Therefore, the first and second transparent substrates 101 and 103 may be formed using a film formed of polyethylene terephthalate (PET), polycarbonate (PC), polyethersulfone (PES), polyimide (PI), polymethlymethacrylate (PMMA), cyclo-olefin polymers (COP), or the like, or a transparent material such as soda glass or tempered glass.

The first and second sensor electrodes 110a and 110b may be formed on lower surfaces of the first and second transparent substrates 101 and 103, respectively.

The first and second sensor electrodes 110a and 110b used in the touch panel 100 according to another exemplary embodiment of the present disclosure may be formed using the electrode layer 11 of the touch panel 10 according to the above-mentioned exemplary embodiment.

That is, the first and second sensor electrodes 110a and 110b may include an electrode layer 111 and a visibility improvement layer 112.

The first and second sensor electrodes 110a and 110b may be formed using a vacuum deposition process such as a sputtering process, an E-beam evaporation process, or the like, an electrolyzing process, such as a plating process, a printing and imprinting process, or the like.

Among the above-mentioned processes, some process may be performed in a state in which the first transparent substrate 101 is positioned below.

The first insulating layer 102 may be formed so as to be interposed between the first and second transparent substrates 101 and 103 to enclose the first sensor electrode 110a.

Further, the second insulating layer 102 may be formed on a lower portion of the second transparent substrate 103 so as to enclose the second sensor electrode 110b.

In the touch panel 100 according to an exemplary embodiment of the present disclosure, the first and second sensor electrodes 110a and 110b and a controller integrated circuit are electrically connected to each other to sense touch input, such that the touch panel 100 may operate.

The controller integrated circuit may detect changes in capacitance generated at the first and second sensor electrodes 110a and 110b by a touch and sense a touch from the change in capacitance.

Therefore, in order to increase the change in capacitance, the first insulating layer 102 may be formed using a material having high permittivity.

The first and second insulating layers 102 and 104 may be formed of an inorganic material containing at least one of SiO₂, Al₂O₃, Ta₂O₅, Nb₂O₅, Si₃N₄, and TiO₂. In this case, the first and second insulating layers 102 and 104 may be manufactured so as to have a thickness of 1 to 10 μm.

In the touch panel 100 according to an exemplary embodiment of the present disclosure, a direction in which the first transparent substrate 101 is formed may be a user's viewing direction of an electronic device.

Therefore, in the touch panel 100 according to an exemplary embodiment of the present disclosure, the visibility improvement layers 112 of the first and second sensor electrodes 110a and 110b may be formed in the direction viewed by the user of the electronic device.

For example, in FIG. 5, the visibility improvement layer 112 may be formed on an upper surface of the electrode layer 111, such that visibility of the touch panel 100 may be improved.

That is, since the visibility improvement layer 112 has a brightness lower than that of the electrode layer 111 to have a dark color, the electrode layer 111 is not visible by the naked eyes of the user of the electronic device.

Therefore, in the case of using the touch panel 100 according to an exemplary embodiment of the present disclosure, a reflective diffraction phenomenon and a moiré phenomenon may be decreased, thereby improving visibility.

Further, since the visibility improvement layer 112 has electrical conductivity, a separate additional process for electrically connecting the first and second sensor electrodes 110a and 110b and the controller integrated circuit to each other is not required.

FIG. 6 shows a schematic cross-sectional view of a touch panel 200 according to another exemplary embodiment of the present disclosure, including visibility improvement layers 212a and 212b on upper and lower surfaces of an electrode layer 211.

A description of the same configurations as those shown in FIG. 5 will be omitted.

Referring to FIG. 5, in the first and second sensor electrodes 210a and 210b, the visibility improvement layers 212a and 212b may be formed on both surfaces of the electrode layer 211.

Since the visibility improvement layers 212a and 212b have high corrosion resistance as compared to the electrode layer 211, in the case in which the visibility improvement layers 212a and 212b are formed on both surfaces of the electrode layer 211, the visibility improvement layers 212a and 212b may serve to protect the electrode layer 211.

Therefore, reliability of the touch panel 200 according to an exemplary embodiment of the present disclosure may be improved.

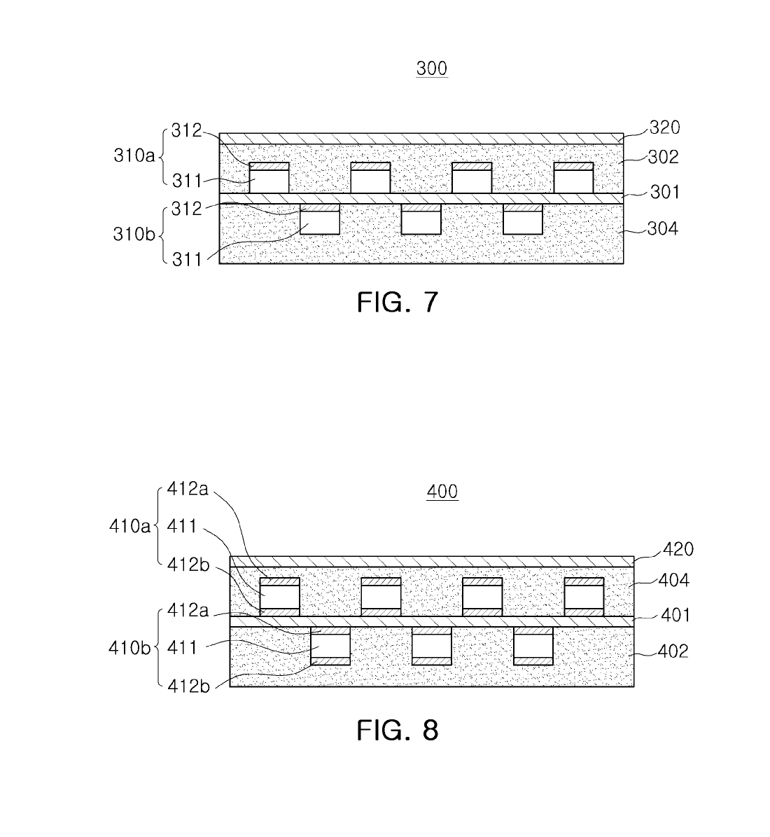

FIG. 7 shows a schematic cross-sectional view of a touch panel 300 according to another exemplary embodiment of the present disclosure.

Referring to FIG. 7, the touch panel according to another exemplary embodiment of the present disclosure may include a transparent substrate 301, a first sensor electrode 310a, a first insulating layer 302, a second sensor electrode 310b, a second insulating layer 304, and a cover layer 320.

In the case of a mobile device, generally, a touch panel may be provided in a state in which it is integrally with a display apparatus, and the touch panel needs to have a high light transmittivity high enough to transmit a screen displayed by the display apparatus.

Therefore, the transparent substrates 301 may be formed using a film formed of polyethylene terephthalate (PET), polycarbonate (PC), polyethersulfone (PES), polyimide (PI), polymethlymethacrylate (PMMA), cyclo-olefin polymers (COP), or the like, or a transparent material such as soda glass or tempered glass.

The first sensor electrode 310a may be formed on an upper surface of the transparent substrate 301, and the second sensor electrode 310b may be formed on a lower surface of the transparent substrate 301.

The first and second sensor electrodes 310a and 310b used in the touch panel 300 according to another exemplary embodiment of the present disclosure may be formed using the electrode layer 11 of the touch panel 10 according to the above-mentioned exemplary embodiment.

That is, the first and second sensor electrodes 310a and 310b may include an electrode layer 311 and a visibility improvement layer 312.

The first and second sensor electrodes 310a and 310b may be formed by a vacuum deposition process such as a sputtering process, an E-beam evaporation process, or the like, an electrolyzing process such as a plating process, a printing and imprinting process, or the like.

The first insulating layer 302 may be formed on the transparent substrate 301 so as to enclose the first sensor electrode 310a.

Further, the second insulating layer 304 may be formed on a lower portion the transparent substrate 301 so as to enclose the second sensor electrode 310b.

The cover layer 320 may be formed on the first insulating layer 302.

The cover layer 320 may be formed using the same material as that of the transparent substrate 301.

In the touch panel 300 according to an exemplary embodiment of the present disclosure, the first and second sensor electrodes 310a and 310b and a controller integrated circuit are electrically connected to each other to sense touch input, such that the touch panel 300 may operate.

The controller integrated circuit may detect changes in capacitance generated at the first and second sensor electrodes 310a and 310b by a touch, and sense a touch from the change in capacitance.

Therefore, in order to increase the change in capacitance, the first insulating layer 302 may be formed using a material having high permittivity.

The first and second insulating layers 302 and 304 may be formed of an inorganic material containing at least one of SiO₂, Al₂O₃, Ta₂O₅, Nb₂O₅, Si₃N₄, and TiO₂. In this case, the first and second insulating layers 302 and 304 may be manufactured so as to have a thickness of 1 to 10 μm.

In the touch panel 300 according to an exemplary embodiment of the present disclosure, a direction in which the cover layer 320 is formed may be a user's viewing direction of an electronic device.

Therefore, in the touch panel 300 according to an exemplary embodiment of the present disclosure, the visibility improvement layers 312 of the first and second sensor electrodes 310a and 310b may be formed in the direction viewed by the user of the electronic device.

For example, in FIG. 7, the visibility improvement layer 312 may be formed on an upper surface of the electrode layer 311, such that visibility of the touch panel 300 may be improved.

That is, since the visibility improvement layer 312 has a brightness lower than that of the electrode layer 311 to have a dark color, the electrode layer 311 is not visible by the naked eyes of the user of the electronic device.

Therefore, in the case of using the touch panel 300 according to an exemplary embodiment of the present disclosure, a reflective diffraction phenomenon and a moiré phenomenon may be decreased, thereby improving visibility.

Further, since the visibility improvement layer 312 has electrical conductivity, a separate additional process for electrically connecting the first and second sensor electrodes 310a and 310b and the controller integrated circuit to each other is not required.

FIG. 8 is a schematic cross-sectional view of a touch panel according to another exemplary embodiment of the present disclosure, including visibility improving layers on upper and lower surfaces of an electrode layer.

A description of the same configurations as those shown in FIG. 7 will be omitted.

Referring to FIG. 8, in first and second sensor electrodes 410a and 410b, the visibility improvement layers 412a and 412b may be formed on both surfaces of the electrode layer 411.

Since the visibility improvement layers 412a and 412b have high corrosion resistance as compared to the electrode layer 411, in the case in which the visibility improvement layers 412a and 412b are formed on both surfaces of the electrode layer 411, the visibility improvement layers 412a and 412b may serve to protect the electrode layer 411.

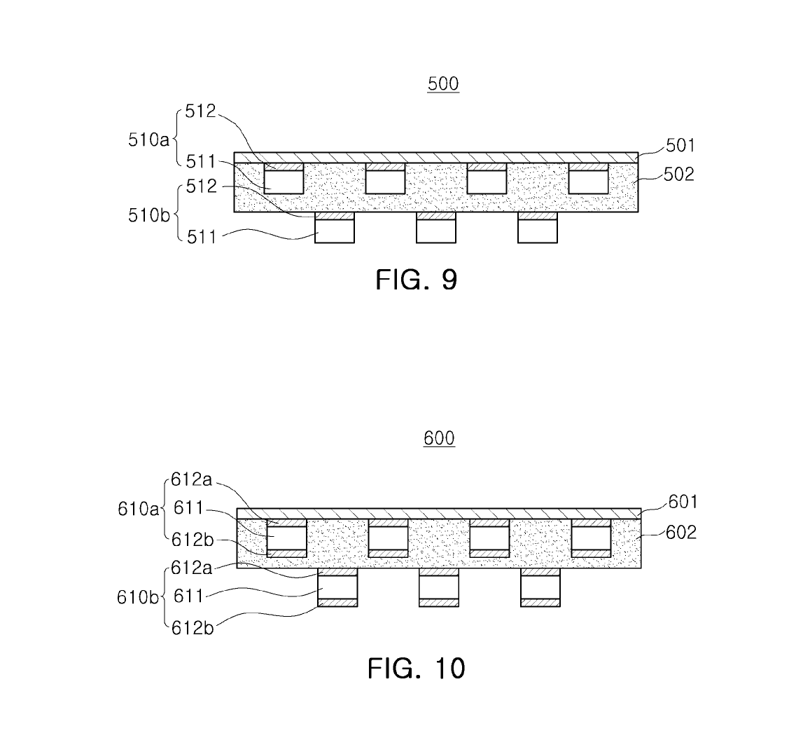

FIG. 9 shows a schematic cross-sectional view of a touch panel 500 according to another exemplary embodiment of the present disclosure.

Referring to FIG. 9, the touch panel 500 according to another exemplary embodiment of the present disclosure may include a transparent substrate 501, a first sensor electrode 510a, an insulating layer 502, and a second sensor electrode 510b.

In the case of a mobile device, generally, a touch panel may be provided in a state in which it is integrally with a display apparatus, and the touch panel needs to have a high light transmittivity high enough to transmit a screen displayed by the display apparatus.

Therefore, the transparent substrates 501 may be formed using a film formed of polyethylene terephthalate (PET), polycarbonate (PC), polyethersulfone (PES), polyimide (PI), polymethlymethacrylate (PMMA), cyclo-olefin polymers (COP), or the like, or a transparent material such as soda glass or tempered glass.

The first sensor electrode 510a may be formed on a lower surface of the transparent substrate 501, and the insulating layer 502 may be formed on a lower portion of the first sensor electrode 510a.

The insulating layer 502 may be formed so as to enclose the first sensor electrode 510a. In addition, the second sensor electrode 510b may be formed on a lower portion of the insulating layer 502.

Further, in order to protect the second sensor electrode 510b, a protection layer (not shown) may be formed on the lower portion of the insulating layer 502 so as to enclose the second sensor electrode 510a.

The insulating layer 502 may be formed using an optically clear adhesive (OCA).

The first and second sensor electrodes 510a and 510b used in the touch panel 500 according to another exemplary embodiment of the present disclosure may be formed using the electrode layer 11 of the touch panel 10 according to the above-mentioned exemplary embodiment.

That is, the first and second sensor electrodes 510a and 510b may include an electrode layer 511 and a visibility improvement layer 512.

The first and second sensor electrodes 510a and 510b may be formed by a vacuum deposition process such as a sputtering process, an E-beam evaporation process, or the like, an electrolyzing process such as a plating process, a printing and imprinting process, or the like.

In the touch panel 500 according to an exemplary embodiment of the present disclosure, the first and second sensor electrodes 510a and 510b and a controller integrated circuit are electrically connected to each other to sense touch input, such that the touch panel 500 may operate.

The controller integrated circuit may detect changes in capacitance generated at the first and second sensor electrodes 510a and 510b by a touch, and sense a touch from the change in capacitance.

Therefore, in order to increase the change in capacitance, the insulating layer 502 may be formed using a material having high permittivity.

The insulating layer 502 may be formed of an inorganic material containing at least one of SiO₂, Al₂O₃, Ta₂O₅, Nb₂O₅, Si₃N₄, and TiO₂. In this case, the insulating layer 502 may be manufactured so as to have a thickness of 1 to 10 μm.

In the touch panel 500 according to an exemplary embodiment of the present disclosure, a direction in which the transparent substrate 501 is formed may be a user's viewing direction of an electronic device.

Therefore, in the touch panel 500 according to an exemplary embodiment of the present disclosure, the visibility improvement layers 512 of the first and second sensor electrodes 510a and 510b may be formed in the direction viewed by the user of the electronic device.

For example, in FIG. 9, the visibility improvement layer 512 may be formed on the upper surface of the electrode layer 511, such that visibility of the touch panel 500 may be improved.

That is, since the visibility improvement layer 512 has a brightness lower than that of the electrode layer 511 to have a dark color, the electrode layer 511 is not visible by the naked eyes of the user of the electronic device.

Therefore, in the case of using the touch panel 500 according to an exemplary embodiment of the present disclosure, a reflective diffraction phenomenon and a moiré phenomenon may be decreased, thereby improving visibility.

Further, since the visibility improvement layer 512 has electrical conductivity, a separate additional process for electrically connecting the first and second sensor electrodes 510a and 310b and the controller integrated circuit to each other is not required.

FIG. 10 shows a schematic cross-sectional view of a touch panel 600 according to another exemplary embodiment of the present disclosure, including visibility improvement layers 612a and 612b on upper and lower surfaces of an electrode layer 611.

A description of the same configurations as those shown in FIG. 9 will be omitted.

Referring to FIG. 10, in first and second sensor electrodes 610a and 610b, the visibility improvement layers 612a and 612b may be formed on both surfaces of the electrode layer 611.

Since the visibility improvement layers 612a and 612b have high corrosion resistance as compared to the electrode layer 611, in the case in which the visibility improvement layers 612a and 612b are formed on both surfaces of the electrode layer 611, the visibility improvement layers 612a and 612b may serve to protect the electrode layer 611.

As set forth above, since the touch panel according to the exemplary embodiment of the present disclosure includes the visibility improvement layer formed on one surface of the electrode layer and having a brightness lower than that of the electrode layer, the electrode layer may not be recognized by the user, such that the visibility may be improved.

In addition, since the touch panel according to another exemplary embodiment of the present disclosure includes the visibility improvement layer, the refractive diffraction phenomenon and moiré phenomenon may be decreased, such that the visibility may be improved.

While exemplary embodiments have been shown and described above, it will be apparent to those skilled in the art that modifications and variations could be made without departing from the spirit and scope of the present disclosure as defined by the appended claims.

What is claimed is:

1. A touch panel comprising:
an electrode layer having a net pattern; and
a visibility improvement layer disposed on at least one surface of the electrode layer and having electrical conductivity.

2. The touch panel of claim 1, wherein the visibility improvement layer contains at least one selected from a group consisting of TiN, CrN, TiNxOy (0<x<1, 0<y<1), and CrNxOy (0<x<1, 0<y<1).

3. The touch panel of claim 1, wherein the visibility improvement layer has a thickness of 20 nm to 90 nm.

4. The touch panel of claim 1, wherein the visibility improvement layer is disposed on both surfaces of the electrode layer.

5. A touch panel comprising:
a transparent substrate;
a first sensor electrode including an electrode layer, which has a net pattern, and a visibility improvement layer disposed on at least one surface of the electrode layer, and disposed on a lower surface the transparent substrate;
an insulating layer disposed on the lower surface the transparent substrate so as to enclose the first sensor electrode; and
a second sensor electrode including an electrode layer, which has a net pattern, and a visibility improvement layer disposed on at least one surface of the electrode layer, and disposed on a lower surface the insulating layer,
wherein the visibility improvement layer has electrical conductivity.

6. The touch panel of claim 5, wherein the visibility improvement layer contains at least one selected from a group consisting of TiN, CrN, TiNxOy (0<x<1, 0<y<1), and CrNxOy (0<x<1, 0<y<1).

7. The touch panel of claim 5, wherein the visibility improvement layer has a thickness of 20 nm to 90 nm.

8. The touch panel of claim 5, wherein the visibility improvement layer is positioned on one surface of the electrode layer in a user's viewing direction.

9. The touch panel of claim 5, wherein the visibility improvement layer is disposed on both surfaces of the electrode layer.

10. A touch panel comprising:
a transparent substrate;
a first sensor electrode including an electrode layer, which has a net pattern, and a visibility improvement layer disposed on at least one surface of the electrode layer, and disposed on an upper surface of the transparent substrate;
a second sensor electrode including an electrode layer, which has a net pattern, and a visibility improvement layer disposed on at least one surface of the electrode layer, and disposed on a lower surface of the transparent substrate,
wherein the visibility improvement layer has electrical conductivity.

11. The touch panel of claim 10, wherein the visibility improvement layer contains at least one selected from a group consisting of TiN, CrN, TiNxOy (0<x<1, 0<y<1), and CrNxOy (0<x<1, 0<y<1).

12. The touch panel of claim 10, wherein the visibility improvement layer has a thickness of 20 nm to 90 nm.

13. The touch panel of claim 10, wherein the visibility improvement layer is positioned on one surface of the electrode layer in a user's viewing direction.

14. The touch panel of claim 10, wherein the visibility improvement layer is disposed on both surfaces of the electrode layer.

15. The touch panel comprising:
a first transparent substrate;
a first sensor electrode including an electrode layer, which has a net pattern, and a visibility improvement layer disposed on at least one surface of the electrode layer, and disposed on a lower surface of the first transparent substrate;
a first insulating layer disposed on the lower surface of the first transparent substrate so as to enclose the first sensor electrode;
a second transparent layer disposed on a lower surface of the first insulating layer;
a second sensor electrode including an electrode layer, which has a net pattern, and a visibility improvement layer disposed on at least one surface of the electrode layer, and disposed on a lower surface of the second transparent substrate; and
a second insulating layer disposed on a lower surface of the second transparent substrate so as to enclose the second sensor electrode,
wherein the visibility improvement layer has electrical conductivity.

16. The touch panel of claim 15, wherein the visibility improvement layer is positioned on one surface of the electrode layer in a user's viewing direction.

17. The touch panel of claim 15, wherein the visibility improvement layer is disposed on both surfaces of the electrode layer.
